(19) United States
(12) Patent Application Publication
(10) Pub. No.: US 2012/0154434 A1
(43) Pub. Date: Jun. 21, 2012

(54) Human Interactive Proofs Leveraging Virtual Techniques

(75) Inventor: Mihai Costea, Redmond, WA (US)

(73) Assignee: Microsoft Corporation, Redmond, WA (US)

(21) Appl. No.: 12/975,078

(22) Filed: Dec. 21, 2010

(51) Int. Cl. G09G 5/00; G06T 11/00

(52) U.S. Cl. 345/629; 345/470

(57) ABSTRACT

Human interactive proofs that leverage virtual techniques are described. In one or more implementations, an object is inserted to be displayed as part of a virtual scene and the virtual scene having the object is exposed as a human interactive proof that includes a question that relates to the inserted object.

### BACKGROUND

Through the Internet, web providers have made many types of web-based resources freely available to users, such as email accounts, search services, and instant messaging. Unfortunately, malicious entities may take advantage of freely available resources to use them for illegitimate and undesirable purposes, such as spamming, web attacks, and virus distribution. To frustrate the efforts of these malicious entities, Human Interactive Proofs (HIPs) have been employed to help determine whether an actual human user is attempting to access a resource. Doing so creates barriers to malicious entities that make use of automated systems to abuse or overuse freely available resources.

One traditional technique for a human interactive proof involves presenting a text-based puzzle. This technique involves challenging a computing device (e.g., a client) with a text-based puzzle when the computing device attempts to access resources. Typically, the answer to the puzzle is text within the puzzle that has been obfuscated in some manner to make it difficult for a computer to recognize. Recently, improvements in optical character recognition (OCR) have all but defeated the viability of the traditional text-based puzzles for HIP. Accordingly, some traditional HIP techniques may no longer be capable of creating a successful barrier to malicious entities.

### SUMMARY

Human interactive proofs leveraging virtual techniques are described. In one or more implementations, an object is inserted to be displayed as part of a virtual scene and the virtual scene having the object is exposed as a human interactive proof that includes a question that relates to the inserted object.

In one or more implementations, a human interactive proof is received at a client device that includes a scene taken from a three-dimensional virtual world and a question. A communication is formed by the client device that includes a proposed answer to the question that, if validated, is configured to permit access to a resource.

In one or more implementations, a three-dimensional virtual world is generated and a plurality of slices is taken from the three-dimensional virtual world. One or more of the slices are transmitted as part of a human interactive proof that is used to control access to a resource.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an environment in an example implementation that is operable to employ virtual human interactive proof techniques.

FIG. 2 illustrates an example user interface that may be output by a client device of FIG. 1 to display a human interactive proof generated at least in part using a virtual world.

FIG. 3 illustrates an example user interface that may be output by a client device of FIG. 1 to display a human interactive proof that includes an object inserted therein that is a subject of a question of the proof.

FIG. 4 is a flow diagram depicting a procedure in an example implementation in which an object in inserted into a virtual scene that is exposed as part of a human interactive proof.

FIG. 5 is a flow diagram depicting a procedure in an example implementation in which a scene is generated from a virtual world for use as part of a human interactive proof.

### DETAILED DESCRIPTION

Overview

This document describes image-based human interactive proofs (HIPs). In some cases these proofs are used when a browser at a client is employed to navigate to a web server to access resources. Before permitting access to the resources, the web server can challenge the client with a virtual human interactive proof, e.g., a human interactive proof that leverages a virtual world.

Traditional “text-based” puzzles consist of images that contain obfuscated text. In order to solve these puzzles, users prove that they can recognize the obfuscated text (e.g., by typing in the text). Due to advances in optical-character recognition technology, however, these puzzles are increasingly easier to solve automatically.

Rather than using traditional text-based puzzles, the techniques described herein employ proofs that make use of images taken from a virtual environment. Some proofs are configured to ask for input of a description of one or more objects presented in a scene taken from the virtual environment. For example, a proof may request input to describe something that is included in the scene, ask for a description of a characteristic in the scene, and so on.

Thus, these proofs may be crafted to rely upon capabilities and creativity that humans possess and computers lack, which makes it difficult for a computer to derive a valid answer to the proof. Accordingly, proofs that involve virtual components enable distinctions to be made between input from humans and input from computers (e.g., non-human input). More particularly, a web server can use answers given in response to the proofs as evidence of a human's interaction.

To perform these proofs, a web server may obtain answers in response to presentation of proofs to clients. For instance, an input may describe a characteristic of a virtual world that is communicated from a client to a web server as an answer. The web server receives this answer from the client and determines whether the answer came from a person or was non-human input. To do so, the web server can compare the received answer to one or more answers known to be from humans. Based on this comparison, the web server can determine if the answer came from a human or computer and selectively enable client access to resources accordingly. In at least some embodiments, the web server can make use of a community database that stores client answers to proofs to assist in distinguishing between human input and non-human input.

In the discussion that follows, a section entitled “Example Environment” describes an environment in which the embodiments can be employed. After this, a section describes example procedures that may be implemented in the example environment and elsewhere. Accordingly, the example environment is not limited to performance of the example procedures and the example procedures are not limited to being performed in the example environment.

Example Environment

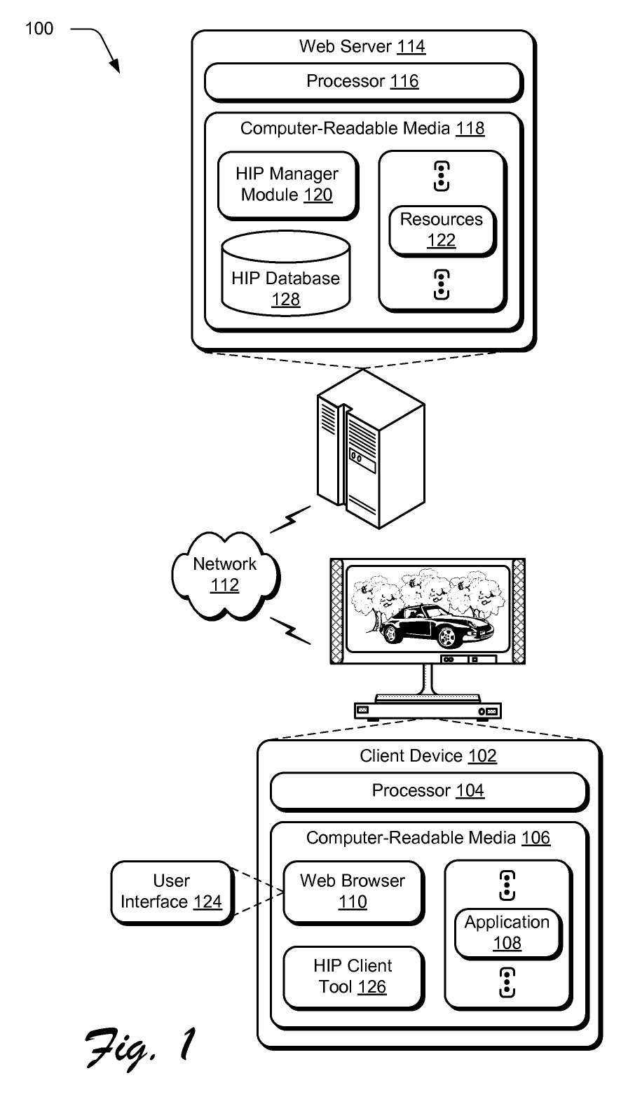

FIG. 1 illustrates an operating environment in accordance with one or more embodiments, generally at 100. Environment 100 includes a client device 102 having one or more processors 104, one or more computer-readable media 106, and one or more applications 108 that reside on the computer-readable media 106, and which are executable by the processor 104. Applications 108 can include any suitable type of application such as an operating system, productivity applications, multimedia applications, email applications, instant messaging applications, and a variety of other applications. The client device 102 can be embodied as any suitable computing device such as a desktop computer, a portable computer, a handheld computer such as a personal digital assistant (PDA), cell phone, and the like.

Client device 102 also includes a web browser 110. The web browser 110 represents functionality available to a user of the computing device 102 to navigate over a network 112, such as the Internet, to one or more web servers 114 from and to which content can be received and sent. The web browser 110 can operate to output a variety of user interfaces through which the user may interact with content that is available from the one or more web servers 114.

The web server 114 represents an example of an online server that may be accessible to the client via the Internet, an intranet, or another suitable network. The web server 114 or other suitable online server (e.g., a corporate server, data server, and so forth) may provide an online presence of a service provider through which clients may obtain corresponding content.

The example web server 114 of FIG. 1 includes one or more processors 116 and one or more computer-readable media 118. The computer-readable media 106 and/or 118 can include, by way of example and not limitation, all forms of volatile and non-volatile memory and/or computer storage media that are typically associated with a computing device. Such media can include ROM, RAM, flash memory, optical disks, hard disk, removable media and the like. Aspects of the techniques described herein may be implemented in hardware, software, or otherwise. In a software context, the techniques may be implemented via program modules stored in the computer-readable media 106 and/or 118 and having instructions executable via the processors 104 and/or 116.

The computer-readable media 106 and/or 118 that may be configured to maintain instructions that cause the computing device, and more particularly hardware of a computing device to perform operations. Thus, the instructions function to configure the hardware to perform the operations and in this way result in transformation of the hardware to perform functions. The instructions may be provided by the computer-readable medium to the computing device through a variety of different configurations.

One such configuration of a computer-readable medium is signal bearing medium and thus is configured to transmit the instructions (e.g., as a carrier wave) to the hardware of the computing device, such as via the network 112. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

The web server 114 can also be configured to enable or otherwise make use of a human interactive proof (HIP) manager module 120 that operates as described herein. The HIP manager module 120 represents a variety of functionality operable to distinguish human-based interaction from non-human interaction, such as automated input from a computer. For example, the HIP manager module 120 may generate human interactive proofs that leverage virtual techniques and selectively enable client access to a variety of resources 122 based on these human interactive proofs.

Web server 114 is illustrated as having resources 122. The web server 114 can implement the HIP manager module 120 to selectively provide the resources 122 to clients in accordance with HIP techniques described herein. As used herein, the resources 122 can include services and/or content available to clients via a web server. Some examples of such resources include email service, search service, instant messaging service, shopping service, web-based applications, web pages, multimedia content, television content, and so forth.

When a client attempts to access resources, the HIP manager module 120 can be configured to present an HIP that includes a scene taken from a virtual world and a question. The proof can be communicated over the network for execution by the client 102. For instance, a web browser 110 of a client 102 can receive a proof communicated from the web server 114. The web browser 110 can output a user interface 124 at the client 102 that incorporates the proof, such as the example user interface 124 depicted in FIG. 1.

In one or more embodiments, a client can implement or make use of an HIP client tool 126 as depicted in FIG. 1. The HIP client tool 126 may represent client-side functionality operable to implement aspects of HIP techniques described herein. For instance, the HIP client tool 126 can interact with the HIP manager module 120 of a web server 114 to obtain a proof, cause output of the proof via the web browser 110, receive input related to the proof, and communicate responses back to the HIP manager module 120. While illustrated as a stand-alone module, the HIP client tool 126 can also be implemented as a component of the web browser.

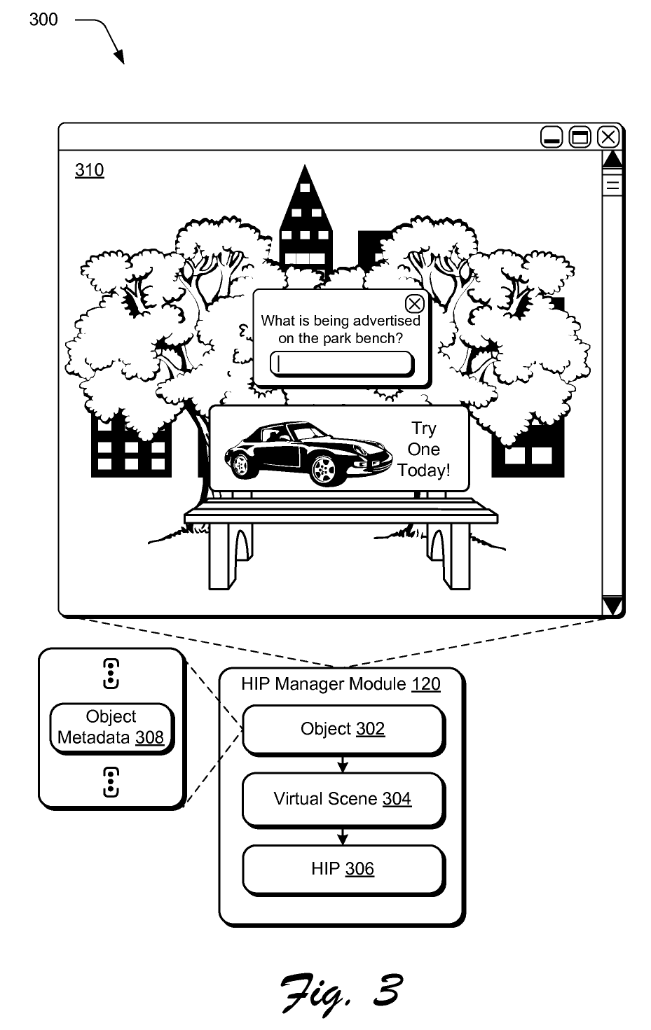

The example web server 114 of FIG. 1 also includes an HIP database 128. HIP database 128 represents functionality to store a variety of data related to HIP techniques described herein. For example, HIP database 128 can store images taken from virtual worlds that may be output to clients via the HIP manager module 120 and/or the HIP client tool 126. Data maintained by the HIP database 128 can also include answers to proofs that are to be received from clients. Further, data in the HIP database 128 can include objects that may be inserted into virtual scenes as further described in relation to FIG. 3.

The data maintained in the HIP database can assist the HIP manager module 120 in distinguishing between human input and non-human input. The HIP manager module 120 can analyze, combine, or otherwise make use of the data to arrive at one or more answers that are considered valid for a given proof. For instance, the HIP manager module 120 can reference the database to compare an answer from a client to one or more answers known to be from humans and/or to answers to the proof that are collected from other clients. By so doing, the HIP manager module 120 uses the HIP database 128 to implement a community-based aspect whereby answers that are valid for a given proof can be based at least in part upon answers from a community of users.

Consider an example in which a client attempts to set-up an email account or other user account with a web provider via the web server 114. Often, malicious entities use automated computer systems to establish numerous accounts with web providers for illegitimate or questionable purposes, such as for email spamming, web-attacks, virus distribution, and so forth. HIP techniques described herein can be employed to make it more difficult for malicious entities to set-up these accounts. By enabling web providers to distinguish between human input and non-human input, image-based puzzles can act as a barrier that makes it more difficult for “non-legitimate” entities to obtain accounts. While user account set-up is described as an example, HIP techniques can be used in a variety of other settings. Generally, the techniques can be applied wherever resources are made freely available and/or it is desirable to prevent overuse and abuse that can occur through automated access to resources.

Generally, any of the functions described herein can be implemented using software, firmware, hardware (e.g., fixed logic circuitry), manual processing, or a combination of these implementations. The terms “module” and “functionality” as used herein generally represent hardware, software, firmware, or a combination thereof. In the case of a software implementation, the module, functionality, or logic represents instructions and hardware that performs operations specified by the hardware, e.g., one or more processors and/or functional blocks. Having considered an example operating environment, consider now a discussion of embodiments in which human interactive proofs (HIPs) can be generated by leveraging virtual techniques.

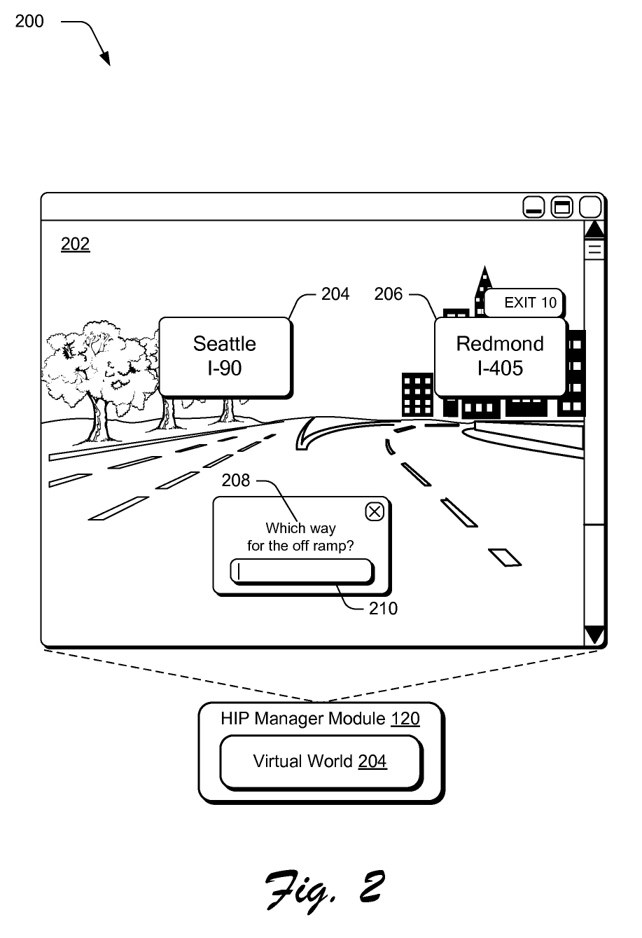

FIG. 2 illustrates an example user interface 200 that may be output by the client device 102 to display a human interactive proof generated at least in part using a virtual world. The user interface 200 includes a two-dimensional image 202 taken of a three-dimensional virtual world 204. In the illustrated example, the virtual world was configured to mimic an actual physical location, which in this instance is an expressway. For example, the illustrated virtual world 204 may be configured for use in an auto racing game, for use by a navigation device, and so on. Other virtual worlds are also contemplated that do not mimic actual physical locations, such as games involving imaginary locations, collections of avatars, and so on.

The image 202 includes a highway having an off ramp. Signs are also shown above the highway and off ramp, a first sign 204 indicates that the highway “I-90” continues on to Seattle. The second sign 206 indicates that the off ramp leads to Redmond via I-405 and it is exit 10.

The image 202 also includes a question 208 relating to what is shown in the image 202 and a portion 210 that is configured to input an answer to the question 208. The question 208 may be configured in a variety of ways such that a correct answer is likely to come from a human being as opposed to a machine In the illustrated example, the question asks “which way for the off ramp?” This may be difficult for a machine to determine because first the machine would determine “what” is an off ramp as well as determine an underlying meaning of the rest of the question 208. However, a human may readily determine an answer to the question 208.

In one or more implementations, a variety of different answers may considered a valid response. For example, a first answer may say “right” as the off ramp is to the right. Other answer may includes “to the right,” “the right two lanes,” and so on. Thus, in each of these examples the answer is not described using text in the scene 202. However, other implementations are also contemplated, such as answers that involve “exit 10,” “Redmond,” “I-405,” and so on. Further, the HIP database 128 may be leveraged to employ heuristics for “wrong” answers given by users to determine whether additional answers should be considered valid.

In this example, the scene 202 was taken from the virtual world 204 and user directly as part of a human interactive proof. In another example, objects may be inserted into the scene for use as a human interactive proof, further discussion of which may be found in relation to the following figure.

FIG. 3 illustrates an example user interface 300 that may be output by a client device 102 of FIG. 1 to display a human interactive proof that includes an object inserted therein that is a subject of a question of the proof. In this example, an object 302 is inserted into a virtual scene 304 to act as a human interactive proof (HIP) 306. A variety of different virtual scenes may be employed, such as slices taken from a three-dimensional virtual world or even other such scenes that were defined and generated using a computing device.

Additionally, a variety of different objects 302 may be inserted into the virtual scene 204, such as advertisements, other images, geometric shapes, and so on. Further, these objects 302 may be associated with object metadata 308 that may serve as a basis for valid answers to a question included in the HIP 306.

For example, the image 310 taken from the HIP 306 is illustrated as including a park scene having a park bench and trees that is backed by a city skyline. The object 302 in this case is an advertisement that is shown as a back of the park bench, much like an advertisement may be displayed on a bench in real life.

The HIP 306 also includes a question “What is being advertised on the park bench?” Answers to the question that are considered valid may leverage the object metadata 308, which may describe the object 302 being inserted into the virtual scene 304. For example, valid answers may include “car” and synonyms thereof (e.g., automobile or auto), a make and model of the car, and so on. As before, the object does not include text in this example that would be considered a valid answer to the question. However, other implementations are also contemplated including inclusion of text in the advertisement that would be considered a valid answer to the question, e.g., a make and/or model of the car.

In this example, the inclusion of advertisements in the HIP 306 may serve as a basis for a revenue model. Because interaction with the HIP 306 in this example viewing the advertisement as well as describing characteristics of the advertisement, advertisers are guaranteed that the advertisement has been viewed by prospective customers. Further discussion of insertion of objects 302 into virtual scenes 304 of HIP 306 may be found in relation to the following procedures.

Example Procedures

The following discussion describes human interactive proof techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to the environment 100 of FIG. 1 and the user interfaces 200, 300 of FIGS. 2 and 3.

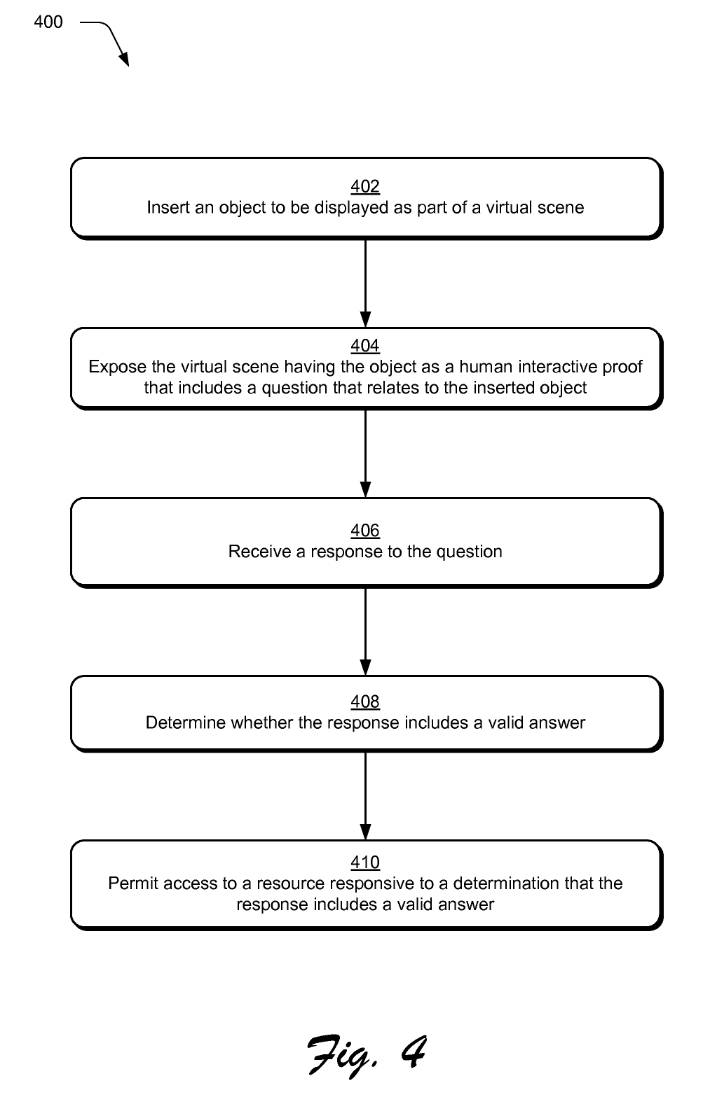

FIG. 4 depicts a procedure 400 in an example implementation in which an object in inserted into a virtual scene that is exposed as part of a human interactive proof An objected is inserted to be displayed as part of a virtual scene (block 402). The object may be configured and obtained in a variety of ways. For example, advertisers may pay to have an advertisement for a good or service inserted into the virtual scene. In another example, the object may be generated virtually from a catalog of objects that are to be inserted into the scene, such as from a selection of “does not belong” objects that may be readily identified by a user as being “out of place” in the scene. A variety of other examples are also contemplated, such as a hot link to an image obtained from an Internet search and therefore the metadata may involve the link itself, and so on.

The virtual scene having the object is exposed as a human interactive proof that includes a question that relates to the inserted object (block 404). Continuing with the previous example, the object may be associated with metadata that describes the object. This metadata may be used as a basis for a valid answer to a question that is asked as part of the human interactive proof. The HIP manager module 120, for instance, may form the question automatically and without user intervention based on what words are contained in the metadata and the type of advertisement. For example, the HIP manager module 120 may determine from the metadata that a car is being advertised and therefore ask a make and/or model of the car, ask what is being advertised, and so on.

A response to the question is received (block 406) and a determination is made as to whether the response includes a valid answer (block 408). The HIP manager module 120, for instance, may receive a response from the client device 102 via the network 112. The response may include one or more words that are entered into a text entry portion of the user interface. The HIP manager module 120 may then compare words in the response with acceptable words for the HIP to determine whether the response is valid. Access may then be permitted to a resource responsive to a determination that the response includes a valid answer (block 410). In this way, the HIP may leverage virtual worlds that may be readily generated for other purposes (e.g., games) as well as revenue collection techniques configured for those worlds, e.g., billboard advertisements in a car racing game, product placement, and so on.

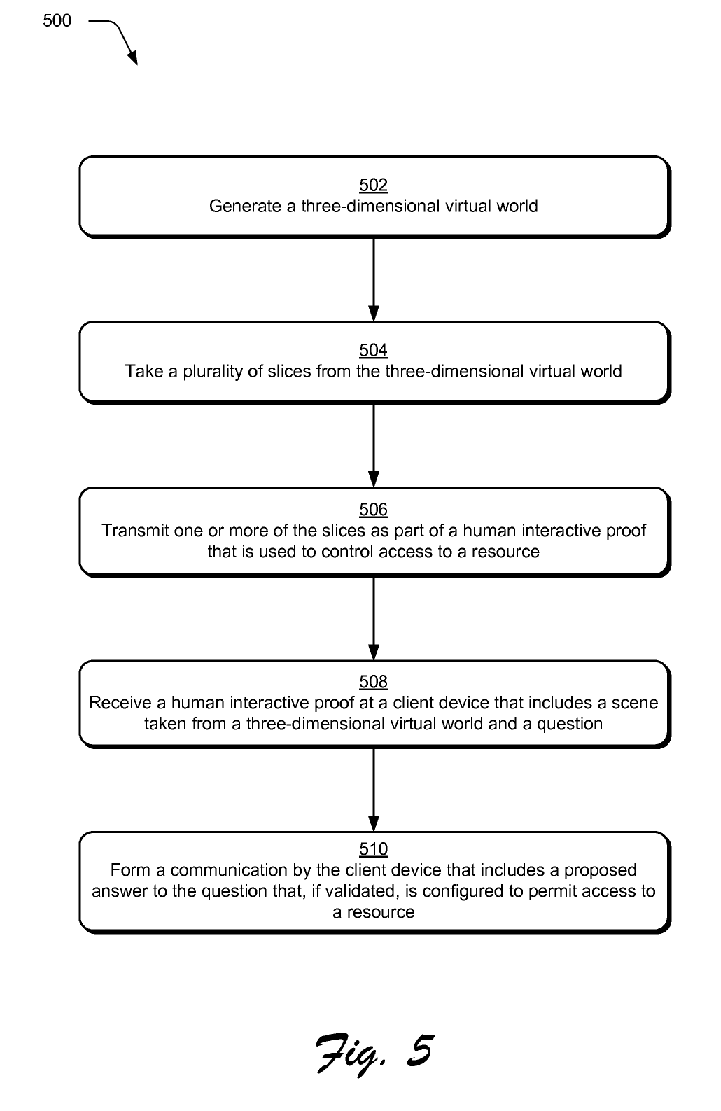

FIG. 5 depicts a procedure 500 in an example implementation in which a scene is generated from a virtual world for use as part of a human interactive proof. A three-dimensional virtual world is generated (block 502). For example, a game-rendering engine may be leveraged to generate the world such that the world in defined in three dimensions, even though it may be displayed using a traditional display device, e.g., a computer monitor, or even using three-dimensions, e.g., using a three-dimensional television. Other three-dimensional worlds are also contemplated, such as using rendering techniques involving navigation devices such as GPS devices.

A plurality of slices is taken from the three-dimensional virtual world (block 504). The slices, for instance, may be taken of different locations in the virtual world, different views of the virtual world, and so on. In another instance, the slices may be taken at different points in time, such as if the virtual world employed one or more animations to show movement of items in the world, e.g., a driving car, flying plane and banner having an advertisement, product placement (e.g., a rolling can of soda), and so forth. Thus, slices may be made temporally and/or based on locations, e.g., different camera views in the virtual world.

One or more of the slices are transmitted as part of a human interactive proof that is used to control access to a resource (block 506). For example, a single slice may be transmitted as an image in the HIP as discussed and shown in relation to FIGS. 2 and 3. A plurality of slices may also be transmitted as a video to the client device 102. The video, for instance, may make it difficult for malicious techniques that were used to circumvent HIPs by creating a relatively large file size, streaming video that is difficult (e.g., expensive computationally and/or regarding network bandwidth) to communicate via the network 112, and so on.

A client device may then receive a human interactive proof that includes a scene taken from a three-dimensional virtual world and a question (block 508). The client device 102, for instance, may receive a scene taken from an online game that includes an inserted object configured as an advertisement. A communication is formed, by the client device, that includes a proposed answer to the question that, if validated, is configured to permit access to a resource (block 510). The answer in the response, for instance, may be compared with a plurality of answers that, if matching, are considered valid. The plurality of answer may include synonyms, different words that can be used to describe an object and/or what the object is doing, and so on. If validated, access to a resource may be granted, such as an email site, photo sharing site, and so on. For instance, the access may involve opening an account to gain access to the resource and thus the HIP may be provided as part of the signup process. A variety of other instances are also contemplated without departing from the spirit and scope thereof

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more computing devices, the method comprising:
inserting an object to be displayed as part of a virtual scene; and
exposing the virtual scene having the object as a human interactive proof that includes a question that relates to the inserted object.

2. A method as described in claim 1, wherein the object as exposed in the virtual scene does not include text that is sufficient to provide a valid answer to the question.

3. A method as described in claim 1, wherein the object has associated metadata that describes the object and the question leverages the metadata.

4. A method as described in claim 1, wherein the object is an advertisement.

5. A method as described in claim 1, wherein the virtual scene is a two-dimensional image taken from a three-dimensional virtual world.

6. A method as described in claim 5, wherein the virtual world is created as part of a video game.

7. A method as described in claim 1, wherein the virtual scene is part of a video that is exposed as the human interactive proof.

8. A method as described in claim 1, further comprising:
receiving a response to the question; and
permitting access to a resource responsive to a determination that the response includes a valid answer to the question.

9. A method comprising:
receiving a human interactive proof at a client device that includes a scene taken from a three-dimensional virtual world and a question; and
forming a communication by the client device that includes a proposed answer to the question that, if validated, is configured to permit access to a resource.

10. A method as described in claim 9, wherein the scene is a video.

11. A method as described in claim 9, wherein the human interactive proof includes an advertisement and the question relates to the advertisement.

12. A method as described in claim 9, wherein a plurality of answers to the question is valid to permit access to the resource.

13. A method as described in claim 9, wherein the scene does not include text that is sufficient to provide a valid answer to the question.

14. A method as described in claim 9, wherein the three-dimensional virtual world is configured for use as a game.

15. A method as described in claim 9, wherein the three-dimensional virtual world models a physical location.

16. A method implemented by one or more computing devices, the comprising:
generating a three-dimensional virtual world;
taking a plurality of slices from the three-dimensional virtual world; and
transmitting one or more of the slices as part of a human interactive proof that is used to control access to a resource.

17. A method as described in claim 16, wherein the three-dimensional virtual world is animated and the plurality of slices are taken at different times during the animation.

18. A method as described in claim 16, wherein the plurality of slices are taken of different locations in the three-dimensional virtual world.

19. A method as described in claim 16, wherein the transmitting involves a plurality of said slices configured as a video.

20. A method as described in claim 16, wherein the three-dimensional virtual world includes an advertisement and the human interactive proof includes a question relating to the advertisement.
